(19) United States
(12) Patent Application Publication
(10) Pub. No.: US 2017/0024146 A1
(43) Pub. Date: Jan. 26, 2017

(54) MEMORY CONTROLLER, INFORMATION PROCESSING DEVICE, AND CONTROL METHOD

(71) Applicant: FUJITSU LIMITED, Kawasaki-shi (JP)

(72) Inventor: Kodai MORITAKA, Kawasaki (JP)

(73) Assignee: FUJITSU LIMITED, Kawasaki-shi (JP)

(21) Appl. No.: 15/180,127

(22) Filed: Jun. 13, 2016

(30) Foreign Application Priority Data
Jul. 23, 2015 (JP) 2015-145418

(51) Int. Cl. G06F 3/06; G06F 1/06

(52) U.S. Cl. CPC G06F 3/0611; G06F 3/0647; G06F 3/0683; G06F 1/06

(57) ABSTRACT

A memory controller that controls a plurality of memories individually through a communication route common to the plurality of memories, the memory controller including a holding unit that holds latency information, a storage that stores therein a request issued by a processor for a transmission destination memory from among the plurality of memories, an output unit that outputs the request from the storage, a transmitter that delays the request received from the output unit for a delay time based on a latency of the transmission destination memory and a latency of another memory from among the plurality of memories, and transmits the request to the transmission destination memory through the common communication route, and a data transceiver unit that transmits or receives data corresponding to the request through the common communication route after a prescribed time period has elapsed since the output unit output the request.

### CROSS-REFERENCE TO RELATED APPLICATION

This application is based upon and claims the benefit of priority of the prior Japanese Patent Application No. 2015-145418, filed on Jul. 23, 2015, the entire contents of which are incorporated herein by reference.

### FIELD

The embodiments discussed herein are related to a memory controller, an information processing device, and a control method.

### BACKGROUND

A dual-inline memory module (DIMM) provided with, for example, a dynamic random access memory (DRAM) as a memory module is used in a computer such as a personal computer (PC) or a server. A U-DIMM (an unbuffered DIMM), an R-DIMM (a registered DIMM), and an LR-DIMM (a load-reduced DIMM) are examples of a type of DIMM. Further, a monolithic device and a three-dimensional stack (3DS) device are examples of a type of DRAM.

As a DRAM, the monolithic device is provided on the U-DIMM, and one of the monolithic device and the 3DS device is provided on the R-DIMM and the LR-DIMM. As described above, there exist a plurality of types of memories according to the combination of a type of DIMM and a type of provided DRAM.

Processing of reading and writing of a memory is performed at a timing based on a read latency (RL) when reading a memory or based on a write latency (WL) when writing into the memory. The RL refers to a time from when a memory controller transmits a command to a memory to when the memory outputs data, and the WL refers to a time from when the memory controller transmits the command to the memory to when it becomes possible to write data into a DRAM on the memory. As described above, there exist a plurality of types of memories, and the WL and the RL vary according to the type of memory.

Amemory controller is known that sets, according to the type of DIMM, an amount of data delay upon reading or writing of data (see, for example, Patent Document 1). An interface circuit is known that reduces command scheduling constraints of memory circuits (see, for example, Patent Document 2). A memory module is known that includes a function that advances a timing of an output of an address-command signal and a function that delays an output of a control signal (see, for example, Patent Document 3).

Consider the case in which different types of memories A and B are connected to a memory channel that is the same communication route. It is assumed that reading and writing is performed on the memories A and B on the basis of a WL and an RL of the memory A from among the memories A and B that are connected to the same memory channel. In this case, normal reading and writing is performed on the memory A. However, for example, data is transmitted before the memory B becomes writable because a WL and an RL of the memory B are different from the WL and the RL of the memory A, with the result that normal reading and writing is not performed on the memory B. As described above, a problem in which a normal operation is not performed will occur when different types of memories are connected to the same memory channel.
Patent Document 1: International Publication Pamphlet No. WO 2012/095980
Patent Document 2: Japanese National Publication of International Patent Application No. 2009-526323
Patent Document 3: Japanese Laid-open Patent Publication No. 2011-48682

### SUMMARY

According to an aspect of the invention, a memory controller controls a plurality of memories individually through a communication route common to the plurality of memories. The memory includes a holding unit, a storage, an output unit, a transmitter, and a data transceiver unit.

The holding unit holds latency information that indicates a latency of each of the plurality of memories.

The storage stores therein a request issued by a processor for a transmission destination memory from among the plurality of memories.

The output unit outputs the request from the storage.

The transmitter delays the request received from the output unit for a delay time based on a latency of the transmission destination memory and a latency of another memory from among the plurality of memories. Then, the transmitter transmits the request to the transmission destination memory through the common communication route.

After a prescribed time period has elapsed since the output unit output the request, the data transceiver unit transmits or receives data corresponding to the request through the common communication route.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a configuration of an information processing device according to an embodiment;

FIG. 2 is a configuration of a MAC according to the embodiment;

FIG. 3 is a configuration of a command-address generating circuit according to the embodiment;

FIG. 4 illustrates an example of a latency table;

FIG. 5 is a flowchart of processing performed by a command-address converting unit according to the embodiment;

FIG. 6 is a detailed flowchart of processing of obtaining a command address latency;

FIG. 7 is a configuration of a command-address converting unit according to the embodiment;

FIG. 8 is a timing chart that illustrates a write operation of the information processing device according to the embodiment;

FIG. 9 is a timing chart that illustrates a read operation of the information processing device according to the embodiment;

FIG. 10 is a timing chart that illustrates a write operation of an alternative method and the write operation of the embodiment;

FIG. 11 is a timing chart that illustrates a write operation of the information processing device according to the embodiment;

FIG. 12 is a timing chart that illustrates a read operation of the information processing device according to the embodiment; and

FIG. 13 is a variation of the command-address generating circuit according to the embodiment.

### DESCRIPTION OF EMBODIMENTS

Embodiments will now be described with reference to the drawings.

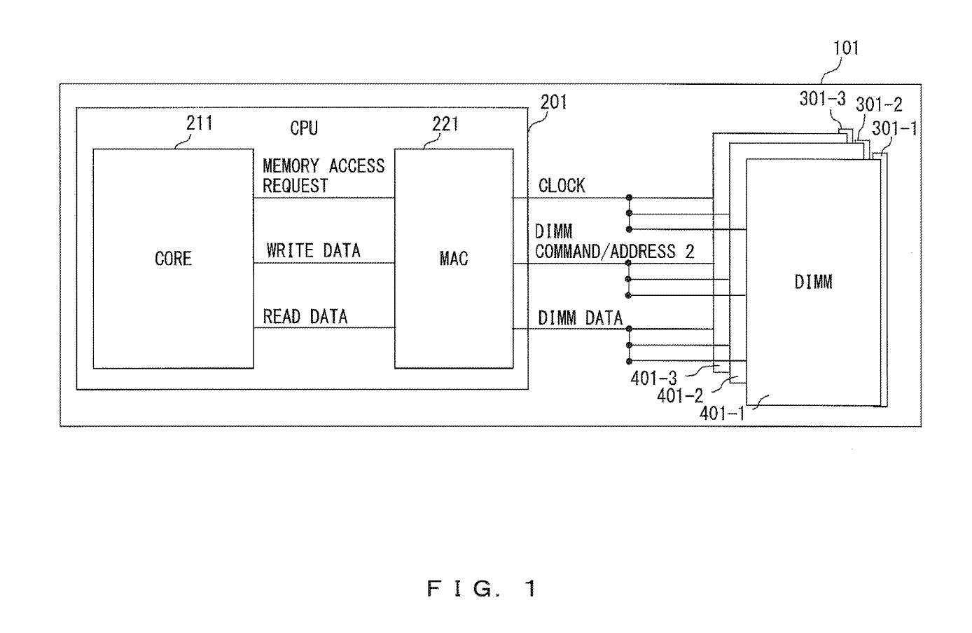

FIG. 1 is a configuration of an information processing device according to an embodiment.

An information processing device 101 includes a central processing unit (CPU) 201, memory slots 301-i (i=1 to 3), and DIMMs 401-i. The information processing device 101 is, for example, a computer such as a PC or a server.

The CPU 201 includes a core 211 and a memory access controller (MAC) 221.

The core 211 issues a request for the DIMM 401-i (a memory access request), and transmits the request to the MAC 221. The core 211 transmits, to the MAC 221, data that is to be written into the DIMM 401-i (write data), and receives, from the MAC 221, data that was read from the DIMM 401-i (read data). The core 211 is an example of an arithmetic processing unit.

On the basis of the request received from the core 211, the MAC 221 transmits a command and an address (a DIMM command/address 2) to the DIMM 401-i so as to control the DIMM 401-i. The MAC 221 transmits a clock signal and write data to the DIMM 401-i, and receives read data from the DIMM 401-i. The MAC 221 is an example of a memory controller. The MAC 221 may be located outside the CPU 201, not inside the CPU 201.

The memory slot 301-i is an opening for insertion that is mounted with a DIMM 401-i. Each memory slot 301-i is mounted with a DIMM 401-i. The memory slots 301-1 to 301-3 may hereinafter be represented by memory slots A to C, respectively.

The DIMM 401-i is a storage that stores therein data used by the information processing device 101. The DIMM 401-i performs reading or writing of data on the basis of a command and an address that are received from the MAC 221. Further, the DIMM 401-i is connected to a memory channel that is the same communication route. In other words, a communication between the MAC 221 and the DIMM 401-i is performed through a memory channel that is common to the DIMM 401-1, the DIMM 401-2, and the DIMM 401-3. Thus, commands, addresses, andpieces of data that are transmitted from the MAC 221 are respectively transmitted to the three DIMMs 401-i through the same memory channel, and pieces of data that are respectively transmitted from the DIMMs 401-i are transmitted to the MAC 221 through the same memory channel. The DIMMs 401-i are different types of memories from one another. The DIMM 401-1 to the DIMM 401-3 may hereinafter be represented by a DIMM A to a DIMM C or by a memory A to a memory C, respectively. The write data transmitted from the MAC 221 to the DIMM 401-i or the read data transmitted from the DIMM 401-i to the MAC 221 may hereinafter be represented by DIMM data.

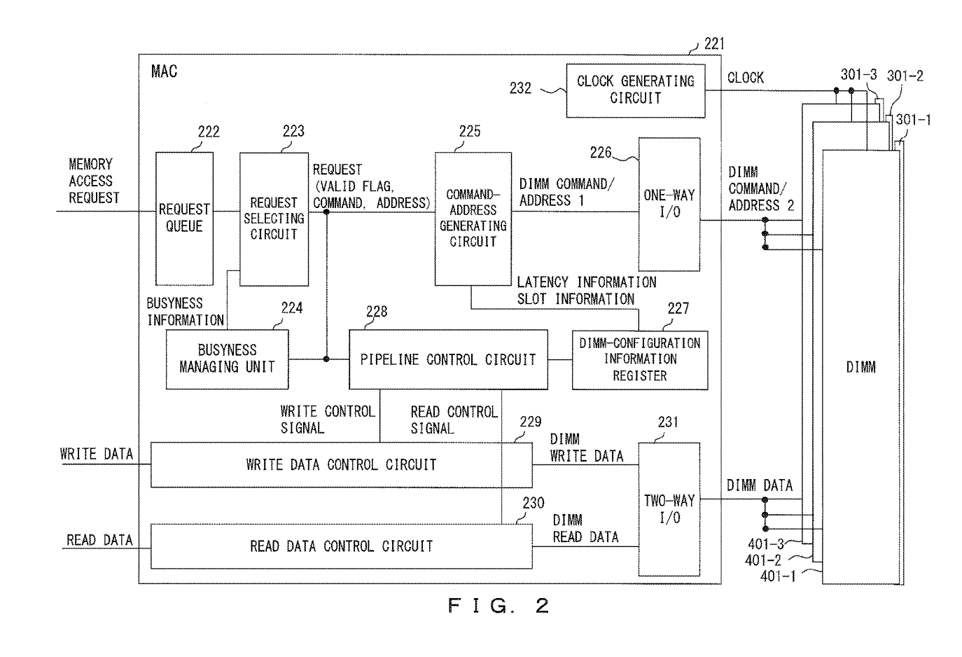

FIG. 2 is a configuration of a MAC according to the embodiment.

The MAC 221 includes a request queue 222, a request selecting circuit 223, a busyness managing unit 224, a command-address generating circuit 225, a one-way input/output (I/O) 226, a DIMM-configuration information register 227, a pipeline control circuit 228, a write data control circuit 229, a read data control circuit 230, a two-way I/O 231, and a clock generating circuit 232.

The request queue 222 stores therein a memory access request received from the core 211. The request queue 222 is, for example, a buffer or a register. The request queue is an example of a storage.

When a busyness-check completion signal is asserted, the request selecting circuit 223 selects one memory access request from the request queue 222 on the basis of busyness information from the busyness managing unit 224, and obtains the selected memory access request. The selected memory access request is deleted from the request queue 222. The request selecting circuit 223 generates a request from the selected memory access request, and outputs the request to the busyness managing unit 224, the command-address generating circuit 225, and the pipeline control circuit 228. The request includes a valid flag, a command, and an address. The valid flag is a flag that indicates whether the request is valid. In this case, the valid flag indicates that the request is valid (=1) . The request selecting circuit 223 is an example of an output unit.

The busyness managing unit 224 receives a request from the request selecting circuit 223. The busyness managing unit 224 generates busyness information on the basis of the request and transmits the busyness information to the request selecting circuit 223. When busyness information is newly generated, the busyness managing unit 224 asserts a busyness-check completion signal for one cycle. The busyness-check completion signal indicates that the request selecting circuit 223 can select a memory access request, and is input into the request selecting circuit 223. It takes a few cycles to perform processing of generating busyness information. The busyness information includes, for example, an address included in a latest received request. When a busyness-check completion signal is asserted, the request selecting circuit 223 selects one memory access request including an address other than the address included in the busyness information, and outputs the memory access request to the command-address generating circuit 225.

The command-address generating circuit 225 generates, from the received request, an address and a command that are to be transmitted to the DIMM 401-i (a DIMM command/address 1), and transmits them to the one-way I/O 226. The command-address generating circuit 225 is an example of a transmitter. The command output from the command-address generating circuit 225 may hereinafter be represented by a DIMM command 1, and the address output from the command-address generating circuit 225 by a DIMM address 1.

The one-way I/O 226 receives the DIMM command/address from the command-address generating circuit 225, and transmits the DIMM command/address 2 to the DIMM 401-i. The DIMM command/address 1 and the DIMM command/address 2 are the same data. Further, it is assumed that it takes one cycle for the one-way I/O 226 to receive and transmit the DIMM command/address 1. The command output from the one-way I/O 226 may hereinafter be represented by a DIMM command 2, and the address output from the one-way I/O 226 by a DIMM address 2.

The DIMM-configuration information register 227 holds (stores therein) information that indicates a write latency and a read latency of each DIMM 401-i (latency information). The latency information is stored in a read only memory (ROM) provided in the DIMM 401-i, and the DIMM-configuration information register 227 obtains the latency information from the ROM. It further holds (stores therein) slot information that indicates which memory slot 301-i is mounted with each DIMM 401-i. The DIMM-configuration information register 227 is an example of a holding unit.

The pipeline control circuit 228 receives a request from the request selecting circuit 223, and when a prescribed time period has elapsed since it received the request, it outputs a write control signal to the write data control circuit 229 or a read control signal to the read data control circuit 230. When the request includes a write command, the prescribed time period is calculated on the basis of a maximum write latency from among the write latencies of the DIMMs 401-i. When the request includes a read command, the prescribed time period is calculated on the basis of a maximum read latency from among the read latencies of the DIMMs 401-i. For example, the prescribed time period is a time period obtained by adding, to the maximum write latency, a time period corresponding to a j cycle (for example, j=1), or a time period obtained by adding, to the maximum read latency, a time period corresponding to a k cycle (for example, j=3).

The write data control circuit 229 stores therein write data transferred from the core 211, and outputs it to the two-way I/O 231 according to the write control signal. The write data output from the pipeline control circuit 228 is represented by DIMM write data.

According to the read control signal, the read data control circuit 230 receives data (DIMM read data) read from the DIMM 401-i, and stores therein the data. The DIMM read data stored in the read data control circuit 230 is transmitted to the core 211 after a prescribed time period has elapsed. The read data output from the two-way I/O 231 is represented by DIMM read data, and the data output from the read data control circuit 230 to the core 211 is represented by read data. A combination of the pipeline control circuit 228, the write circuit control circuit 229, and the read data control circuit 230 is an example of a data transceiver unit.

The two-way I/O 231 transmits, to the DIMM 401-i, the write data (the DIMM write data) received from the write data control circuit. Further, it transmits, to the read data control circuit 230, the read data (the DIMM read data) received from the DIMM 401-i. The DIMM write data and the DIMM read data that are transmitted and received between the two-way I/O 231 and the DIMM 401-i are represented by DIMM data. It is assumed that it takes one cycle for the two-way I/O 231 to receive and transmit the DIMM write data. Further, it is assumed that it takes one cycle for the two-way I/O 231 to receive and transmit the DIMM read data. In other words, it is assumed that it takes one cycle for data to pass through the two-way I/O 231.

The clock generating circuit 232 generates a clock (signal) and transmits it to the DIMM 401-i. The DIMM 401-i operates synchronously with the received clock. Further, the request queue 222, the request selecting circuit 223, the busyness managing unit 224, the command-address generating circuit 225, the one-way I/O 226, the DIMM-configuration information register 227, the pipeline control circuit 228, the write data control circuit 229, the read data control circuit 230, and the two-way I/O 231 also operate synchronously with the generated clock.

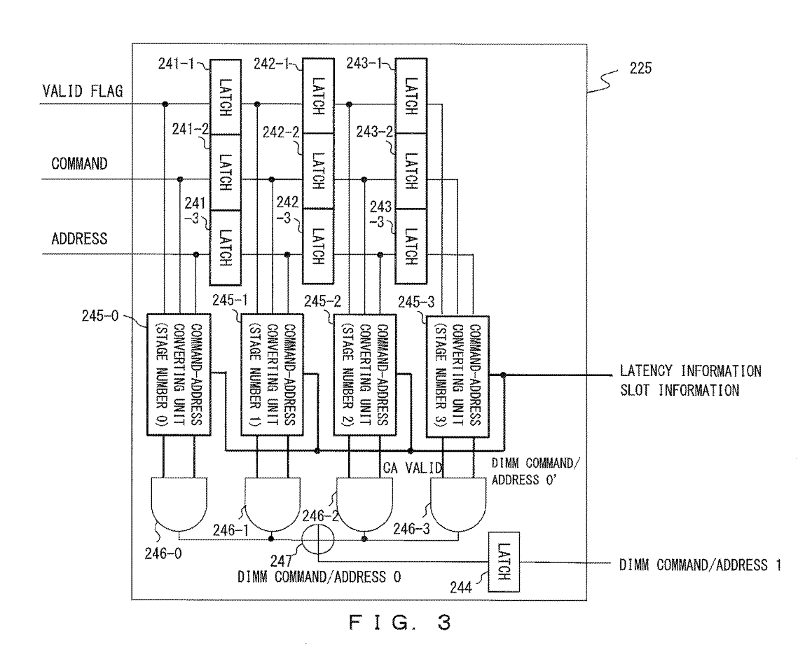

FIG. 3 is a configuration of a command-address generating circuit according to the embodiment.

The command-address generating circuit 225 includes latches 241-i, 242-i, 243-i, and 244, command-address converting units 245-m (m=0 to 3), AND circuits 246-m, and an output unit 247.

Each of the latches 241-i, 242-i, 243-i, and 244 outputs input data one cycle late. A valid flag, a command, and an address are input into each of the latches 241-1 to 241-3. The valid flags, the commands, and the addresses that are output from the latches 241-1 to 241-3 are input into the latches 242-1 to 242-3, respectively. The valid flags, the commands, and the addresses that are output from the latches 241-1 to 241-3 are input into the command-address converting unit 245-1. The valid flags, the commands, and the addresses that are output from the latches 242-1 to 242-3 are input into the latches 243-1 to 243-3, respectively. Further, the valid flags, the commands, and the addresses that are output from the latches 242-1 to 242-3 are input into the command-address converting unit 245-2. The valid flags, the commands, and the addresses that are output from the latches 243-1 to 243-3 are input into the command-address converting unit 245-3.

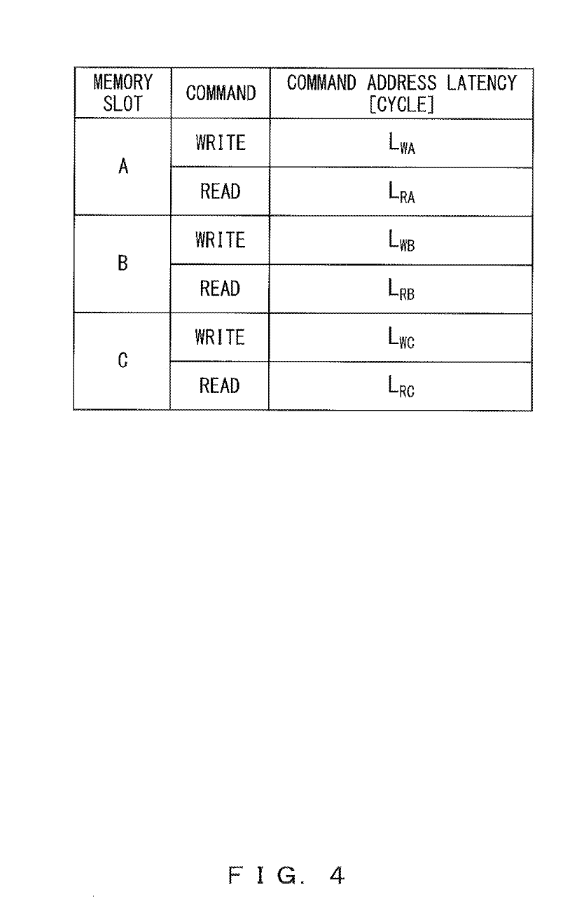

A valid flag, a command, and an address that are delayed for an m-cycle are input into the command-address converting unit 245-m. The command-address converting unit 245-m generates, from the input valid flag, command, and address, a command and an address (a DIMM command/address 0′) for the DIMM 401-i, and outputs them to the AND circuit 246-m. Further, latency information and slot information are input into the command-address converting unit 245-m. The command-address converting unit 245-m generates a command latency table as illustrated in FIG. 4 from the input latency information and slot information.

FIG. 4 illustrates an example of a latency table.

A memory slot, a command, and a command address latency that are associated with one another are included in the latency table.

The memory slot refers to the memory slot 301-i equipped with the DIMM 401-i. For example, A, B, or C is given in MEMORY SLOT, and they refer to the memory slots 301-1 to 301-3, respectively.

The command refers to a type of command, and WRITE or READ is given in COMMAND.

The command address latency refers to a cycle for which a DIMM command/address 1 is forced to wait in the command-address generating circuit 225 to be output.

L_{xy} given in COMMAND ADDRESS LATENCY refers to the number of cycles for which a DIMM command/address 1 corresponding to a DIMM equipped in a memory slot and to a command is forced to wait to be output. x indicates a type of command, x=W (write) or R (read). y indicates a memory slot, and y=A, B, or C. L_{Wy} is a difference between a maximum WLmax from among the WLs of the respective DIMMs 401-i included in the slot information and a WL of each of the DIMMs 401-i. For example, it is assumed that a WL (WL_A) of the DIMM 401-1=a, a WL (WL_B) of the DIMM 401-2=b, and a WL (WL_C) of the DIMM 401-3=c, wherein a≧b and a≧c. In this case, L_{WA}=a−a=0, L_{WB}=a−b, and L=WC=a−c. L_{Ry} is a difference between a maximum RLmax from among the RLs of the respective DIMMs 401-i and an RL of each of the DIMMs 401-i. The cycle for which the DIMM command/address 1 is forced to wait in the command-address generating circuit 225 to be output is referred to as a command address latency.

Return to FIG. 3 to continue the description.

Each command-address converting unit 245-m has a stage number m, and generates a CA valid from a command address latency corresponding to an input request and its stage number m so as to output it to the AND circuit 246-m. The CA valid is a control signal (flag) that indicates whether a DIMM command/address 0′ is valid. For example, when the DIMM command/address 0′ is valid, the CA valid is 1.

When the input CA valid is valid (=1), the AND circuit 246-m outputs the input DIMM command/address 0′ to the output unit 247. When the CA valid is invalid, the AND circuit 246-m does not output the input DIMM command/address 0′ (that is, 0 is output).

The output unit 247 outputs the input DIMM command/address 0′ into the latch 244. In other words, the DIMM command/address 0′ input into the AND circuit 246-m into which the valid CA valid was input is output from the output unit 247. The DIMM command/address 0′ output from the output unit 247 is represented by a DIMM command/address 0.

The latch 244 outputs the input DIMM command/address 0 one cycle late. The DIMM command/address 0 output from the latch 244 is represented by a DIMM command/address 1.

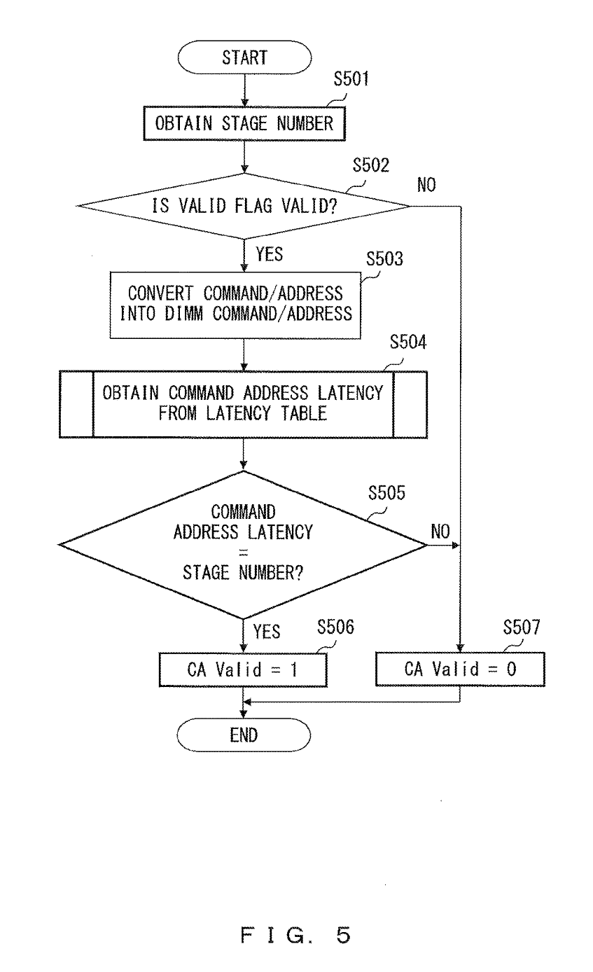

FIG. 5 is a flowchart of processing performed by a command-address converting unit according to the embodiment.

In Step S501, the command-address converting unit 245-m obtains a stage number assigned to itself. The stage number is held (stored), in advance, in, for example, a register (not shown) included in the command-address converting unit 245-m.

In Step S502, the command-address converting unit 245-m determined whether an input valid flag is valid. When the valid flag is valid, the control process moves on to Step S503, and when the valid flag is invalid, the control process moves on to Step S507.

In Step S503, the command-address converting unit 245-m converts the input command and address into a command and an address that are to be transmitted to the DIMM 401-m, that is, it generates a DIMM command/address 0′. For example, it generates the DIMM command/address 0′ by converting an address on a system that is included in a request into the address of the DIMM 401-m.

In Step S504, the command-address converting unit 245-m refers to a latency table, and obtains a command address latency corresponding to the input command and address (a transmission destination DIMM 401-i) (processing of obtaining a command address latency). The processing of obtaining a command address latency will be described in detail later.

In Step S505, the command-address converting unit 245-m compares the obtained command address latency with its stage number. When the command address latency and the stage number are identical, the control process moves onto Step S506, and when they are not identical, the control process moves on to Step S507.

In Step S506, the command-address converting unit 245-m sets a CA valid to be valid (=1) and outputs the DIMM command/address 0′ and the CA valid to the AND circuit 246-m.

In Step S507, the command-address converting unit 245-m sets the CA valid to be invalid (=0) and outputs the DIMM command/address 0′ and the CA valid to the AND circuit 246-m.

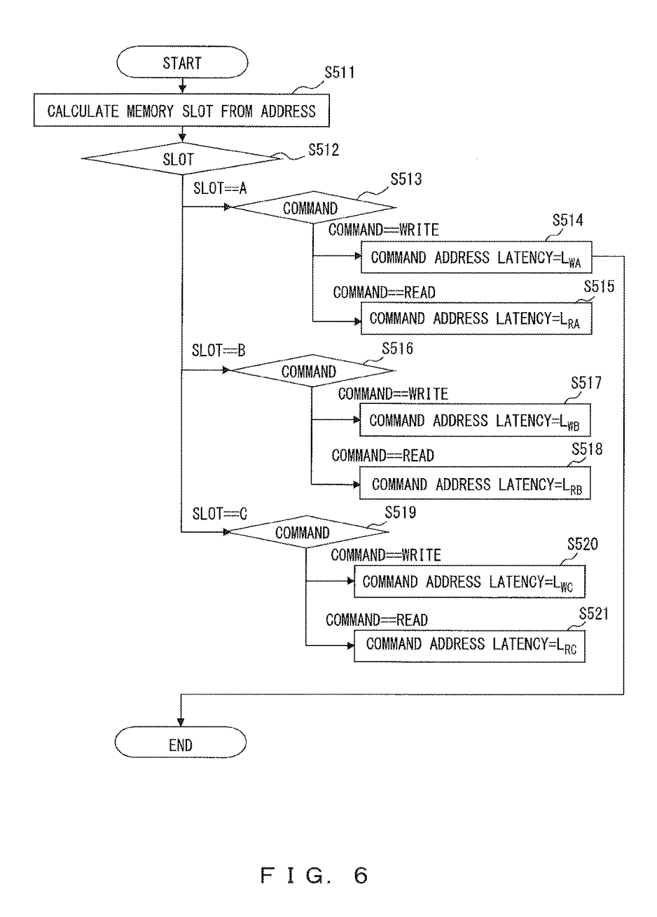

FIG. 6 is a detailed flowchart of the processing of obtaining a command address latency.

FIG. 6 corresponds to Step S504 of FIG. 5.

In Step S511, the command-address converting unit 245-m calculates, from the input address, a memory slot 301-i equipped with a DIMM 401-i to which the request is to be transmitted. It is assumed that the command-address converting unit 245-m knows which address corresponds to which memory slot.

In Step S512, the command-address converting unit 245-m determines which memory slot the calculated memory slot is. When the calculated memory slot is the slot A, B, or C, the control process moves on to Step S513, S516, or S519, respectively.

In Step S513, the command-address converting unit 245-m determines a type of input command. When the input command is “write”, the control process moves on to Step S514, and when the input command is “read”, the control process moves on to Step S515.

In Step S514, the command-address converting unit 245-m obtains the command address latency L_{WA} that corresponds to the memory slot A and “write” in the latency table.

In Step S515, the command-address converting unit 245-m obtains the command address latency L_{RA} that corresponds to the memory slot A and “read” in the latency table.

In Step S516, the command-address converting unit 245-m determines the type of input command. When the input command is “write”, the control process moves on to Step S517, and when the input command is “read”, the control process moves on to Step S518.

In Step S517, the command-address converting unit 245-m obtains the command address latency L_{WB} that corresponds to the memory slot B and “write” in the latency table.

In Step S518, the command-address converting unit 245-m obtains the command address latency L_{RB} that corresponds to the memory slot B and “read” in the latency table.

In Step S519, the command-address converting unit 245-m determines the type of input command. When the input command is “write”, the control process moves on to Step S520, and when the input command is “read”, the control process moves on to Step S521.

In Step S520, the command-address converting unit 245-m obtains the command address latency L_{WC} that corresponds to the memory slot C and “write” in the latency table.

In Step S521, the command-address converting unit 245-m obtains the command address latency L_{RC} that corresponds to the memory slot C and “read” in the latency table.

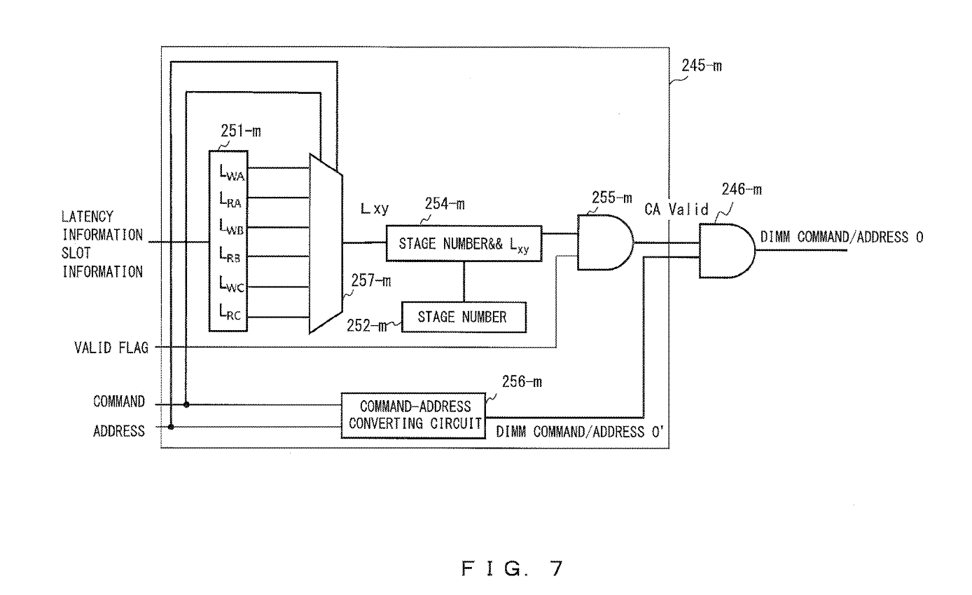

The command-address converting unit 245-m that performs the above-described processing is realized by use of, for example, a configuration as illustrated in FIG. 7.

FIG. 7 is a configuration of the command-address converting unit according to the embodiment.

The command-address converting unit 245-m includes registers 251-m and 252-m, a selector 253-m, a comparison unit 254-m, an AND circuit 255-m, and a command-address converting circuit 256-m.

The register 251-m stores therein the latency table of FIG. 4. The register 251-m outputs to the selector 253-m a command address latency L_{xy} (x=W or R, y=A, B, or C) given in the latency table. The command-address converting unit 245-m creates the latency table on the basis of input latency information and input slot information.

The register 252-m stores therein a stage number m that is assigned to a command-address converting unit 245-m.

The selector 253-m selects, from among the command address latencies L_{xy}, a command-address latency L_{xy} that corresponds to an input command and an input address, and outputs the selected command address latency L_{xy} to the comparison unit 254-m.

The comparison unit 254-m compares the command address latency L_{xy} with the stage number stored in the register 252-m, and when the command address latency L_{xy} and the stage number are identical, it outputs a valid signal (=1) to the AND circuit 255-m. When the command address latency L_{xy} and the stage number are not identical, the comparison unit 254-m outputs a valid signal (=0) to the AND circuit 255-m.

The AND circuit 255-m outputs, to the AND circuit 246-m, a logical AND (CA valid) of the output signal (1 or 0) of the comparison unit 254-m and a valid flag.

The command-address converting circuit 256-m converts the input command and address into a command and an address that are to be transmitted to the DIMM 401-m, that is, it generates a DIMM command/address 0′, and outputs it to the AND circuit 246-m.

Next, a write operation of the MAC according to the embodiment when different types of DIMMs are connected to the same memory channel will be described.

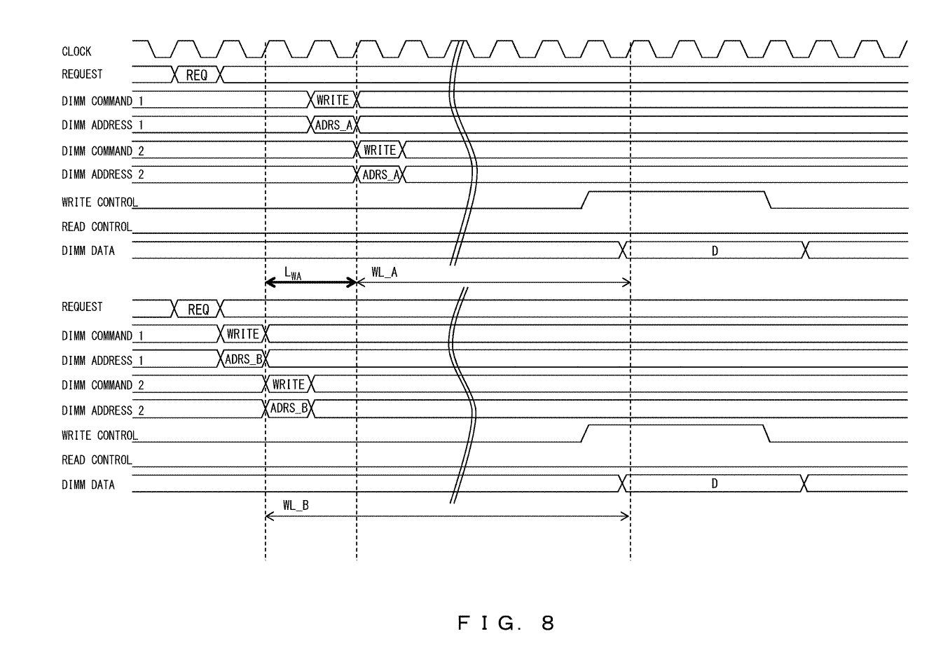

FIG. 8 is a timing chart that illustrates a write operation of the information processing device according to the embodiment.

In this case, write operations for the DIMM 401-1 (DIMM A) and for the DIMM 401-2 (DIMM B) are represented. The timing chart illustrates the write operation for the DIMM 401-1 in the upper portion of FIG. 8 and the write operation for the DIMM 401-2 in the lower portion of FIG. 8.

Here, a difference DWL between a write latency WL_A of the DIMM A and a write latency WL_B of the DIMMB is obtained as follows: DWL=WL_B−WL_A=two cycles. In this case, L_{WA} in the latency table of FIG. 4 is “2”. A DIMM command 1 and a DIMM address 1 (a DIMM command/address 1) that are destined for the

DIMM A are delayed for a cycle corresponding to L_{WA} (=two cycles) with respect to the conventional output timing (one cycle after a request (REQ) is output). As a result, a DIMM command 2 and a DIMM address 2 (a DIMM command/address 2) are also delayed for the cycle corresponding to L_{WA} (=two cycles) with respect to the conventional output timing (two cycles after the request (REQ) is output) so as to be transferred to the DIMM 401-i.

Further, when a maximum value from among the write latencies of the DIMMs 401-i is WL_B, L_{WB} is “0”. Thus, a DIMM command 1 and a DIMM address 1 (a DIMM command/address 1) that are destined for the DIMM B are output at a timing similar to that in the conventional DIMM command-address generating circuit (one cycle after the request (REQ) is output). As a result, a DIMM command 2 and a DIMM address 2 (a DIMM command/address 2) that are destined for the DIMM B are also transmitted to the DIMM 401-i at a timing similar to that in the conventional DIMM command-address generating circuit (two cycles after the request (REQ) is output).

As described above, the DIMM command/address 2 destined for the DIMM B passes through the command-address generating circuit 225 and the one-way I/O 226, so it is transmitted two cycles after a request is output from the request selecting circuit 223. Further, the DIMM command/address 2 destined for the DIMM A is transmitted four (2+L_{WA}(=2)) cycles after the request is output from the request selecting circuit 223 because it is forced to be delayed in the command-address generating circuit 225. In other words, the DIMM command/address 2 destined for the DIMM A is output delayed by a cycle corresponding to L_{WA}, compared with the DIMM command/address 2 destined for the DIMM B.

Further, write controls for the DIMMs A and B are both output WL_B+1 cycles after the request is output from the request selecting circuit 223.

In the above processing, the DIMMs A and B have the same length of time from when a request is issued by the request selecting circuit 223 to when DIMM data and a write control are output, and both of the write latencies WL_A and WL_B with respect to the DIMMs A and B are satisfied. In other words, even when different types of DIMMs, the DIMM A and the DIMM B, are provided on the same memory channel, it is possible to write into the DIMMs A and B normally.

Next, a read operation of the MAC according to the embodiment when different types of DIMMs are provided on the same memory channel will be described.

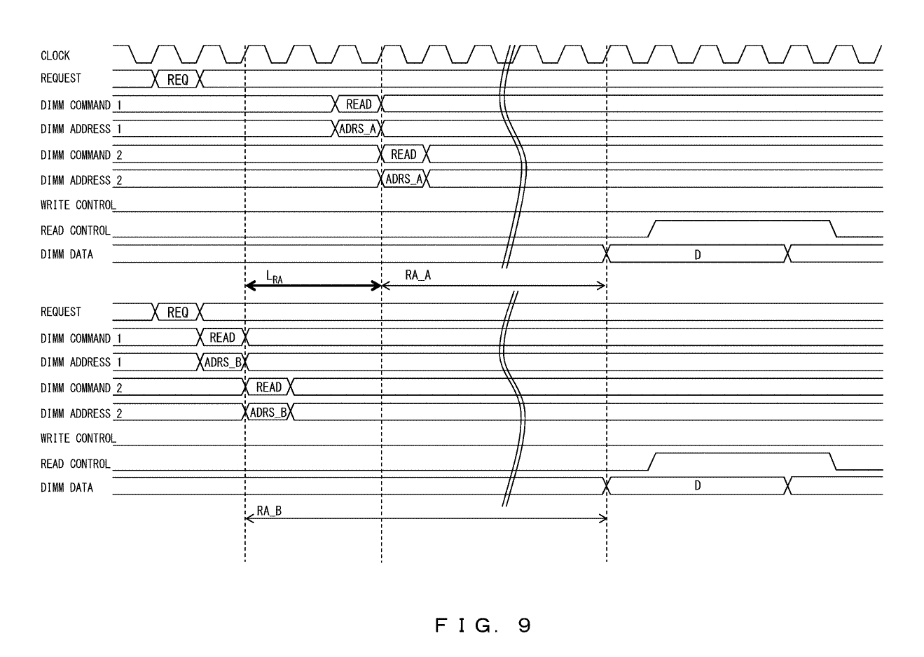

FIG. 9 is a timing chart that illustrates a read operation of the information processing device according to the embodiment.

In this case, read operations for the DIMM 401-1 (DIMM A) and for the DIMM 401-2 (DIMM B) are represented. The timing chart illustrates the read operation for the DIMM 401-1 in the upper portion of FIG. 9 and the read operation for the DIMM 401-2 in the lower portion of FIG. 9.

Here, a difference DRL between a read latency RL_A of the DIMM A and a read latency RL_B of the DIMMB is obtained as follows: DRL=RL_B−RL_A =three cycles. In this case, L_{RA} in the latency table of FIG. 4 is “3”. A DIMM command 1 and a DIMM address 1 (a DIMM command/address 1) that are destined for the DIMM A are delayed for a cycle corresponding to L_{RA}(=three cycles) with respect to the conventional output timing (one cycle after a request (REQ) is output). As a result, a DIMM command 2 and a DIMM address 2 (a DIMM command/address 2) are also delayed for the cycle corresponding to L_{RA} (=three cycles) with respect to the conventional output timing (two cycles after the request (REQ) is output) so as to be transferred to the DIMM 401-i.

Further, when a maximum value from among the read latencies of the DIMMs 401-i is RL_B, L_{RB} is “0”. Thus, a DIMM command 1 and a DIMM address 1 (a DIMM command/address 1) that are destined for the DIMM B are output at a timing similar to that in the conventional DIMM command-address generating circuit (one cycle after the request (REQ) is output). As a result, a DIMM command 2 and a DIMM address 2 (a DIMM command/address 2) that are destined for the DIMM B are also transmitted to the DIMM 401-i at a timing similar to that in the conventional DIMM command/address generating circuit (two cycles after the request (REQ) is output).

As described above, the DIMM command/address 2 destined for the DIMM B passes through the command-address generating circuit 225 and the one-way I/O 226, so it is transmitted two cycles after the request is output from the request selecting circuit 223. Further, the DIMM command/address 2 destined for the DIMM A is transmitted five (2+L_{RA}(=3)) cycles after the request is output from the request selecting circuit 223 because it is forced to be delayed in the command-address generating circuit 225. In other words, the DIMM command/address 2 destined for the DIMM A is output delayed by a cycle corresponding to L_{RA}late, compared with the DIMM command address 2 destined for the DIMM B.

Further, read controls for the DIMMs A and B are both output RL_B+3 cycles after the request is output from the request selecting circuit 223.

In the above processing, the DIMMs A and B have the same length of time from when a request is issued by the request selecting circuit 223 to when DIMM data is received, and both RL_A and RL_B are satisfied. In other words, even when different types of DIMMs, the DIMM A and the DIMM B, are connected to the same memory channel, it is possible to read the DIMMs A and B normally.

As described above, the MAC according to the embodiment permits normal reading and writing even when different types of DIMMs are connected to the same memory channel.

On the other hand, in addition to the control method for delaying the output of a DIMM command address 2 according to the embodiment, there is also a method for varying a timing of reporting a write control signal or a read control signal, so as to delay the output of DIMM data and satisfy a WL and an RL of a provided DIMM 401-i without delaying the output of the DIMM command/address 2. The method for varying a timing of reporting a write control signal or a read control signal is hereinafter simply referred to as an alternative method. The alternative method and the control method according to the embodiment will now be compared.

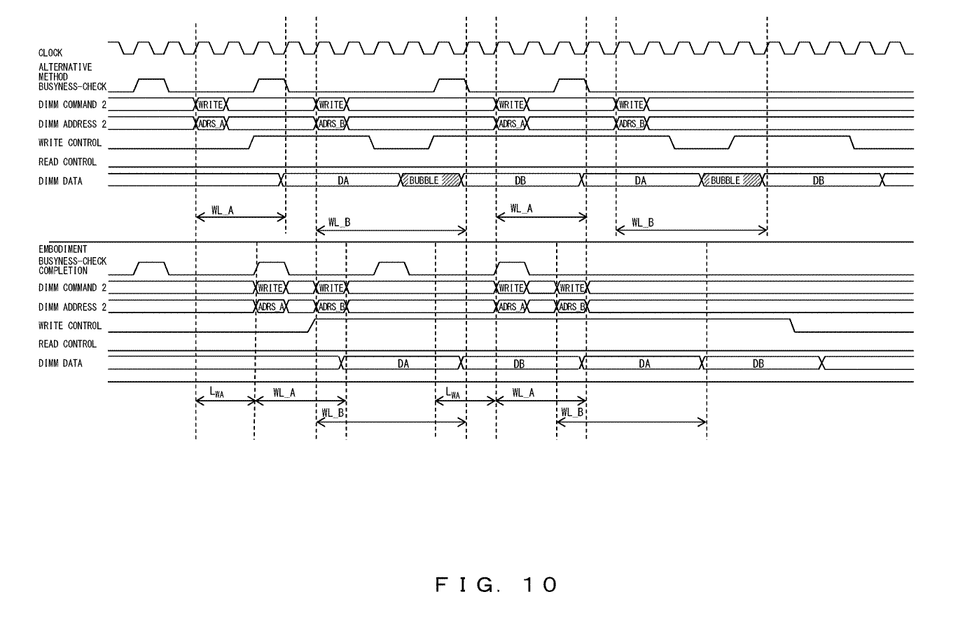

FIG. 10 is a timing chart that illustrates a write operation of the alternative method and the write operation of the embodiment. The timing chart illustrates the write operation of the alternative method in the upper portion of FIG. 10 and the write operation of the embodiment in the lower portion of FIG. 10.

It is assumed that a minimum asserting interval of a busyness-check completion signal is four cycles. The addresses of the DIMMs A and B are represented by ADRS_A and ADRS_B, respectively. Likewise, pieces of DIMM data of the DIMMs A and B are represented by DA and DB, respectively. Further, it is assumed that the write latency WL_A of the DIMMA is and the write latency WL_B of the DIMM B is

In the alternative method, as illustrated in the upper portion of FIG. 10, when writing into the DIMM A is performed, a write control signal is reported to a write data control circuit WL_A−1 cycles after a DIMM command/address 2 is transmitted, and likewise, when writing into the DIMM B is performed, a write control is reported to the write data control circuit WL_B−1 cycles after the DIMM command/address 2 is transmitted. Thus, both WL_A and WL_B are satisfied, which permits different types of DIMMs to coexist on the same memory channel, as is the case in the control method of the embodiment. Here, the two methods are compared in terms of a data throughput. In the alternative method, a bubble that is two-cycle meaningless data is produced without any exception during a DIMM data transfer between the DIMM A and the DIMM B. At this point, when the write operation is performed in a pattern of DIMM A, DIMM B, DIMM A, DIMM B, . . . , the data throughput rate is 80%. If the DIMM command/address 2 is output two cycles ahead, that is, a cycle corresponding to an amount of bubbles ahead, there is no possibility that a bubble will occur, but it is still not possible to prevent the occurrence of a bubble because an asserting interval of a busyness-check completion signal will not be made shorter anymore. On the other hand, in the control method of the embodiment, a two-cycle bubble will not occur even when the write operation is performed in a similar pattern to the alternative method. As a result, the data throughput rate is 100%.

As described above, the control method of the embodiment is superior to the alternative method in terms of a data throughput.

Further, these methods are compared in terms of a circuit size. Compared with the command-address generating circuit 225, the pipeline control circuit 228 is constituted of a long and large pipeline. When the alternative method is provided, an additional circuit (obtaining a stage number, referring to a latency table, comparing a latency for data and the stage number, and generating a valid flag for a data output) is needed for each stage of the long pipeline. Thus, the alternative method needs more additional circuits than the command-address generating circuit 225, with the result that the control method of the embodiment is also superior in terms of a circuit size.

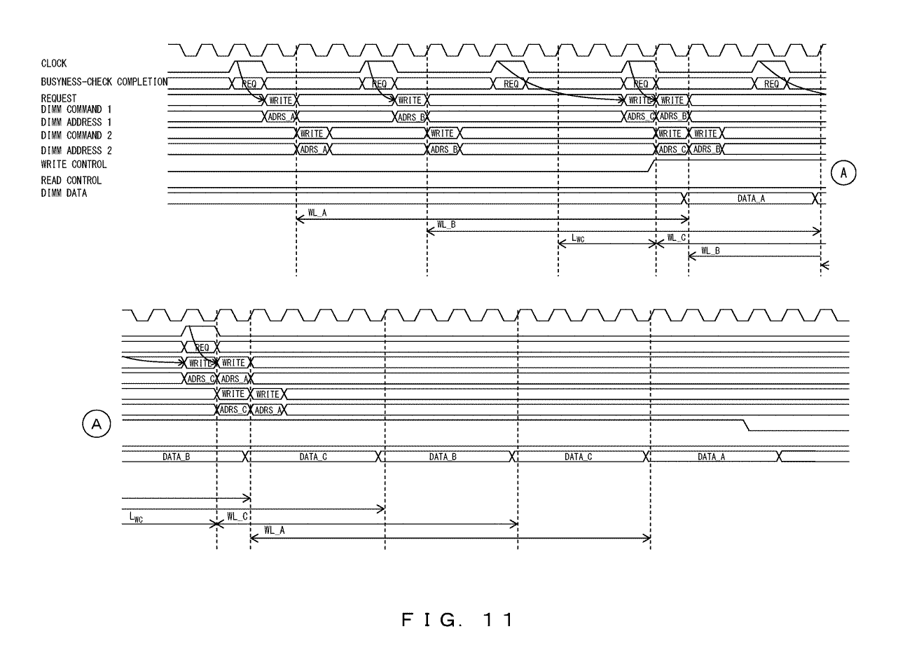

FIG. 11 is a timing chart that illustrates a write operation of the information processing device according to the embodiment.

FIG. 11 illustrates a write operation performed in the information processing device 101 provided with different types of DIMMs, DIMMs A, B, and C. It is assumed that a write latency WL_A of the DIMM A and a write latency WL_B of the DIMM B are as follows: WL_A=WL_B=12. Further, it is assumed that a write latency WL_C of the DIMM C is as follows: WL_C=9. A command address latency L_{WA} for “write” of the DIMM A and a command address latency L_{WB} for “write” of the DIMM B are as follows: L_{WA}=L_{WB}=0. A command address latency L_{WC} for “write” of the DIMM C is as follows: L_{WC}=3. It is assumed that the information processing device 101 performs writing in order of DIMM A, DIMM B, DIMM C, DIMM B, DIMM C, and DIMM A. Further, it is assumed that a busyness-check completion signal is asserted once out of every 4 cycles at the minimum.

Under this condition, a DIMM command 2 and a DIMM address 2 that are destined for the DIMM A and a DIMM command 2 and a DIMM address 2 that are destined for the DIMM B are respectively transmitted to the DIMM A and the DIMM B two cycles after a busyness-check completion signal is asserted. Further, a DIMM command 2 and a DIMM address 2 that are destined for the DIMM C are transmitted to the DIMM C five cycles after the busyness-check completion signal is asserted because they are forced to wait for a cycle corresponding to L_{WC} (=3) in the command-address generating circuit 225.

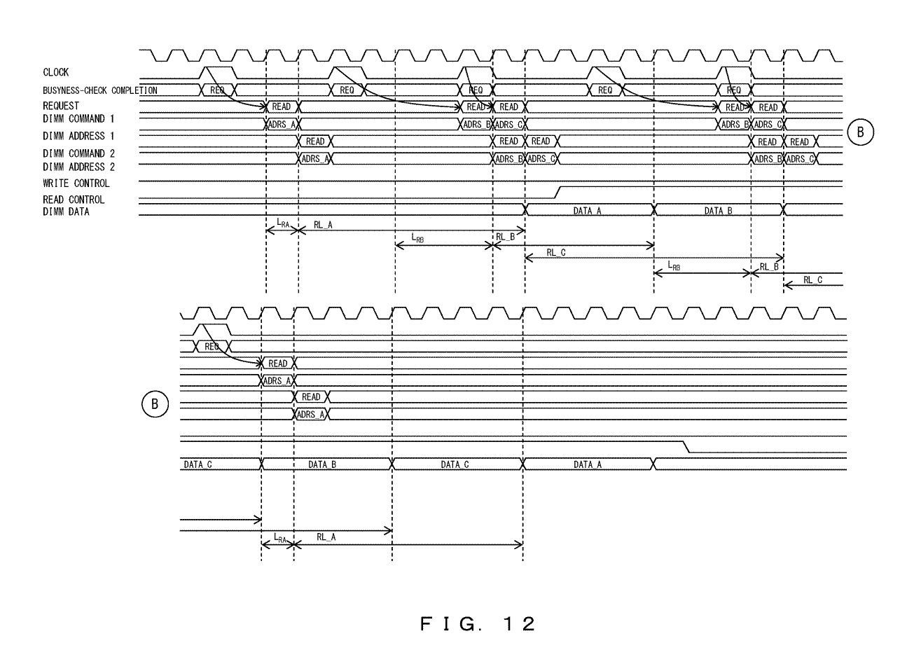

FIG. 12 is a timing chart that illustrates a read operation of the information processing device according to the embodiment.

FIG. 12 illustrates a read operation performed in the information processing device 101 provided with different types of DIMMs, DIMMs A, B, and C. It is assumed that a read latency RL_A of the DIMM A is RL_A=7, a read latency RL_B of the DIMM B is RL_B=5, and a read latency RL_C of the DIMM C is RL_C=8. A command address latency L_{RA} for “read” of the DIMM A, a command address latency L_{RB} for “read” of the DIMM B, and a command address latency L_{RC} for “read” of the DIMM C are L_{RA}=1, L_{RB}=3, and L_{RC}=0. It is assumed that the information processing device 101 performs reading in order of DIMM A, DIMM B, DIMM C, DIMM B, DIMM C, and DIMM A. Further, it is assumed that a busyness-check completion signal is asserted once out of every 4 cycles at the minimum.

Under this condition, a DIMM command 2 and a DIMM address 2 that are destined for the DIMM C are transmitted to the DIMMC two cycles after a busyness-check completion signal is asserted. Further, a DIMM command 2 and a DIMM address 2 that are destined for the DIMM A are transmitted to the DIMM A three cycles after the busyness-check completion signal is asserted because they are forced to wait for a cycle corresponding to L_{RA} (=1) in the command-address generating circuit 225, and a DIMM command 2 and a DIMM address 2 that are destined for the DIMM B are transmitted to the DIMM B five cycles after the busyness-check completion signal is asserted because they are forced to wait for a cycle corresponding to L_{RB} (=3) in the command-address generating circuit 225.

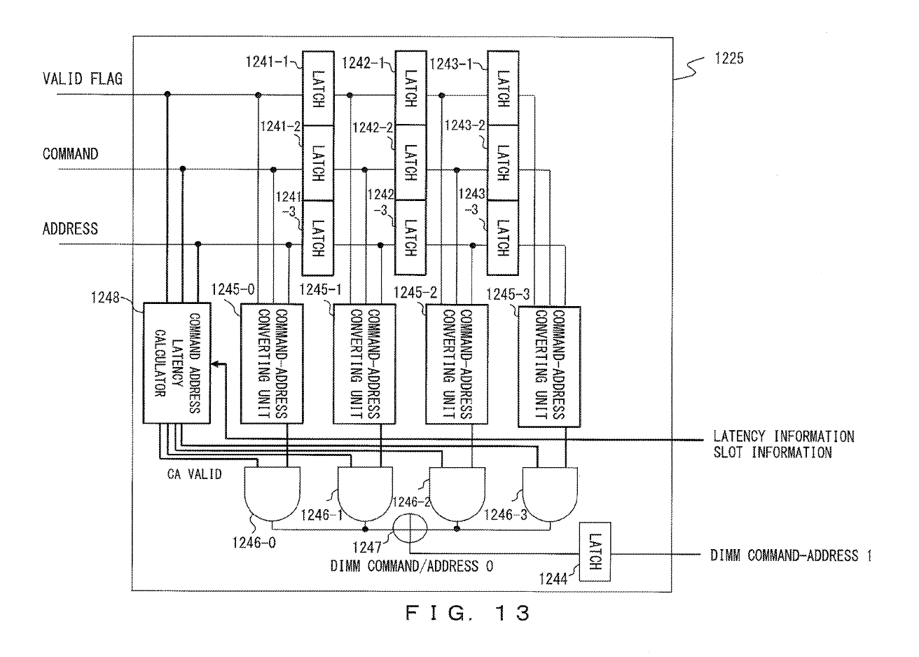

FIG. 13 is a variation of the command-address generating circuit according to the embodiment.

The command-address generating circuit 225 may have a configuration of a command-address generating circuit 1225 as illustrated in FIG. 13.

The command-address generating circuit 1225 includes latches 1241-i, 1242-i, 1243-i, and 1244, command-address converting units 1245-m (m=0 to 3), AND circuits 1246-m, an output unit 1247, and a command address latency calculator 1248.

Each of the latches 1241-i, 1242-i, 1243-i, and 1244 outputs input data one cycle late. A valid flag, a command, and an address are input into each of the latches 1241-1 to 1241-3. The valid flags, the commands, and the addresses that are output from the latches 1241-1 to 1241-3 are input into the latches 1242-1 to 1242-3, respectively. The valid flags, the commands, and the addresses that are output from the latches 1241-1 to 1241-3 are input into the command-address converting unit 1245-1. The valid flags, the commands, and the addresses that are output from the latches 1242-1 to 1242-3 are input into the latches 1243-1 to 1243-3, respectively. Further, the valid flags, the commands, and the addresses that are output from the latches 1242-1 to 1242-3 are input into the command-address converting unit 1245-2. The valid flags, the commands, and the addresses that are output from the latches 1243-1 to 1243-3 are input into the command-address converting unit 1245-3.

A valid flag, a command, and an address that are delayed for an m-cycle are input into the command-address converting unit 1245-m. The command-address converting unit 1245-m generates, from the input valid flag, command, and address, a command and an address (a DIMM command/address 0′) for the DIMM 1401-i, and outputs them to the AND circuit 1246-m.

Latency information and slot information are input into the command address latency calculator 1248. The command address latency calculator 1248 generates a command latency table as illustrated in FIG. 4 from the input latency information and slot information. The command address latency calculator 1248 generates a CA valid so as to output it to the AND circuit 1246-m. A CA valid output by the command address latency calculator 1248 to each AND circuit 1246-m is similar to the CA valid output by the command-address converting unit 245-m of FIG. 3, and is calculated in a method similar to the processing performed by the command-address converting unit 245-m described above.

When the input CA valid is valid (=1), the AND circuit 1246-m outputs the input DIMM command/address 0′ to the output unit 1247. When the CA valid is invalid, the AND circuit 1246-m does not output the input DIMM command/address 0′ (that is, 0 is output).

The output unit 1247 outputs the input DIMM command/address 0′ into the latch 1244. In other words, the DIMM command/address 0′ input into the AND circuit 1246-m into which the valid CA valid was input is output from the output unit 1247. The DIMM command/address 0′ output from the output unit 1247 is represented by a DIMM command/address 0.

The latch 1244 outputs the input DIMM command/address 0 one cycle late. The DIMM command/address 0 output from the latch 1244 is represented by a DIMM command/address 1.

The information processing device according to the embodiment permits a delay in transmitting a command and an address according to a latency of a transmission-destination DIMM, which results in performing a normal operation even when different types of memories are connected to the same memory channel.

All examples and conditional language provided herein are intended for pedagogical purposes to aiding the reader in understanding the invention and the concepts contributed by the inventor to further the art, and are not to be construed as being limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A memory controller that controls a plurality of memories individually through a communication route common to the plurality of memories, the memory controller comprising:
a holding unit configured to hold latency information that indicates a latency of each of the plurality of memories;
a storage configured to store therein a request issued by a processor for a transmission destination memory from among the plurality of memories;
an output unit configured to output the request from the storage;
a transmitter configured to delay the request received from the output unit for a delay time based on a latency of the transmission destination memory and a latency of another memory from among the plurality of memories, and transmits the request to the transmission destination memory through the common communication route; and
a data transceiver unit configured tot transmit or receive data corresponding to the request through the common communication route after a prescribed time period has elapsed since the output unit output the request.

2. The memory controller according to claim 1, wherein
the transmitter calculates the delay time on the basis of a difference between a maximum latency from among the latencies of the plurality of memories and the latency of the transmission destination memory.

3. The memory controller according to claim 2, wherein
the prescribed time period is calculated on the basis of the maximum latency.

4. An information processing device comprising:
a plurality of memories that are connected to a common communication route;
a processor; and
a memory controller configured to control the plurality of memories individually through the common communication route, wherein
the memory controller includes
a holding unit configured to hold latency information that indicates a latency of each of the plurality of memories,
a storage configured to store therein a request issued by the processor for a transmission destination memory from among the plurality of memories,
an output unit configured to output the request from the storage,
a transmitter configured to delay the request received from the output unit for a delay time based on a latency of the transmission destination memory and a latency of another memory from among the plurality of memories, and transmits the request to the transmission destination memory through the common communication route, and
a data transceiver unit configured to transmit or receive data corresponding to the request through the common communication route after a prescribed time period has elapsed since the output unit output the request.

5. The information processing device according to claim 4, wherein
the transmitter calculates the delay time on the basis of a difference between a maximum latency from among the latencies of the plurality of memories and the latency of the transmission destination memory.

6. The information processing device according to claim 5, wherein
the prescribed time period is calculated on the basis of the maximum latency.

7. A control method for controlling an information processing device that includes a processor, a memory controller, and a plurality of memories, the method comprising:
issuing, by the processor, a request for a transmission destination memory from among the plurality of memories;
storing the request in a storage included in the memory controller;
outputting, by the memory controller, the request from the storage;
delaying, by the memory controller, the output request for a delay time based on a latency of the transmission destination memory and a latency of another memory from among the plurality of memories, and transmitting the output request from the memory controller to the transmission destination memory through a communication route common to the plurality of memories; and
transmitting or receiving, by the memory controller, data corresponding to the request through the common communication route after a prescribed time period has elapsed since the request was output.

8. The control method according to claim 7, further comprising
calculating, by the memory controller, the delay time on the basis of a difference between a maximum latency from among the latencies of the plurality of memories and the latency of the transmission destination memory.

9. The control method according to claim 8, wherein
the prescribed time period is calculated on the basis of the maximum latency.
